(19) United States
(12) Patent Application Publication
(10) Pub. No.: US 2011/0276537 A1
(43) Pub. Date: Nov. 10, 2011

(54) SaaS (Software as a Service) Providing User Control of Sharing of Data Between Multiple ERPs

(75) Inventors: Beat Jegerlehner, Los Altos, CA (US); Alex Makarewycz, San Mateo, CA (US); Steven Johnson, Westlake Village, CA (US)

(73) Assignee: ARIBA, INC., San Jose, CA (US)

(21) Appl. No.: 13/099,311

(22) Filed: May 2, 2011

Related U.S. Application Data
(60) Provisional application No. 61/332,296, filed on May 7, 2010.

(51) Int. Cl. G06F 17/30

(52) U.S. Cl. 707/620; 707/736; 707/E17.005

(57) ABSTRACT

Embodiments for methods, systems, apparatuses for an enterprise application providing user control of sharing of data between multiple Enterprise Resource Planning (ERP) systems are disclosed. One method includes identifying types of shared data between the multiple ERPs, conveying the identified shared data types to a user, allowing the user to selectively load shared data to a parent realm based on the identified types of shared data, allowing the user to selectively indicate which data is not to be shared between ERPs to identified child realms, and providing sharing of shared data between child realms.

### RELATED APPLICATIONS

This patent application claims priority to U.S. Provisional Patent Application No. 61/332,296 filed on May 7, 2010 which is herein incorporated by reference.

### FIELD OF THE INVENTION

The described embodiments relate to the field of enterprise resource planning. More specifically, the described embodiments relate to the ability to access multiple external applications simultaneously using a SaaS.

### BACKGROUND OF THE INVENTION

Enterprise Resource Planning (ERP) is an industry standard term to describe the multitude of accounting oriented applications that aid in the planning and support of business process data. For many businesses ERP applications include complex information systems that support and automate business processes such as human resources, manufacturing, distribution, project management, payroll, financials, etc. Building and maintaining the interrelationships between the applications making up an ERP system is a daunting task because each application may have its own set of attributes and business rules. In addition, these applications are developed by various software vendors (e.g. SAP, Oracle, etc.) that may obtain and store the data from a variety of sources (e.g. flat files, relationship databases, etc.).

In an effort to relieve some of the complexity, enterprise applications have been created that provide access to many ERP applications from a single application. For example, buying organizations may use an enterprise application to enable their corporate community of users, approvers, and related departments to acquire all of their operating resources via a single, common networked infrastructure. The enterprise application channels the users to products and services from preferred suppliers while simplifying the numerous processes (e.g., approval within the organization) of acquiring operating resources. That is, the enterprise application facilitates an easy to understand presentation of each process to the user, so complexity is minimized, while still allowing the enterprise to model sophisticated process scenarios.

FIG. 1 illustrates the connectivity of two ERPs with two enterprise applications. Here, enterprise application instance 110 interfaces with ERP 102 and enterprise application instance 120 interfaces with ERP 103. The ERP 102 includes ERP database 130 and ERP database 150. The ERP 103 includes ERP database 140 and ERP database 160.

An enterprise application may model the world using a particular set of objects. Here, ERP object 170 uses the object model from ERP 102. ERP object 180 uses the object model from ERP 103. These ERP objects relate both to real-world objects, such as suppliers and catalog items, as well as to computer items such as folders used to display work in progress to users.

The enterprise application 110 and 120 communicates with their respective ERP in their terms. This means not only importing and exporting the particular kinds of data that a given ERP uses using the object model of the ERP, but also communicating using the idiosyncratic codes of each specific ERP application. Therefore, enterprise application 110 needs to respect the semantics of each and every ERP object model. For instance, SAP may work with a particular accounting model, meaning the enterprise application communicates with it using the business rules and user Ids that the SAP understands, such as, using the SAP's user, not the enterprise application user ID.

However, a problem occurs when wanting to acquire business data not contained in a single ERP application, but spread across several ERPs of different ERP types (e.g. one SAP ERP and one Oracle ERP). Typically this occurs when a business with an existing ERP mergers with or acquires another business which has its own ERP.

For example, two businesses may have merged, each with pre-existing ERP systems of different types (e.g. ERP 102 may use an SAP system while ERP 103 may use an Oracle system). Upon merging both businesses may decide to continue to operate both ERP systems separately because one business is based in the United States and the other in France. However, at times, a user may want to access both instances simultaneously. For example, the user may view reports about both instances. When multiple ERP instances are represented in two distinct instances a user may not immediately view both instances simultaneously in an efficient manner. To view the ERP instances simultaneously the enterprise application unions the instances together or transfers the data from both instances into a data warehouse. Both these methods are inefficient and place additional overhead to the enterprise application.

Another problem with having multiple ERP systems is that different resource data may be required to work with the differing ERP instances. For example, the ERP instance for the United States may contain different resource data attributes and business rules than the ERP instance for France. Most enterprise applications map the differences between the two ERPs at runtime to keep track of which resource data is valid for which systems. However, in many cases it is not possible to map all external semantics into a single representation. Mapping dissimilar representations will result in errors to the business process.

Another possible problem when accessing multiple ERPs is that the enterprise application has to deal with data redundancy (e.g. the possibility that the same logical entity (for instance the same employee) is represented more than once, slightly differently and with potentially conflicting data, in different systems).

It is desirable to have a single program SaaS (Software as a Service) that addresses the above-describe problems associated with a single entity managing multiple ERPs.

### SUMMARY

An embodiment includes a method of an enterprise application providing user control of sharing of data between multiple Enterprise Resource Planning (ERP) systems. The method includes identifying types of shared data between the multiple ERPs, conveying the identified shared data types to a user, allowing the user to selectively load shared data to a parent realm based on the identified types of shared data, allowing the user to selectively indicate which data is not to be shared between ERPs to identified child realms, and providing sharing of shared data between child realms.

Another embodiment includes an enterprise application system that provides user control of sharing of data between multiple Enterprise Resource Planning (ERP) systems. The enterprise application system includes an enterprise application server operable to identify types of shared data between the multiple ERP systems. The enterprise application server is operable to convey the identified shared data types to a user connected to the enterprise application network. The enterprise application server is operable to allow the user to selectively load at least some shared data to a parent realm based on the identified types of shared data. The enterprise application server is operable to allow the user to selectively load data not to be shared between ERP systems to identified child realms. The enterprise application server provides sharing of shared data between child realms.

Another embodiment includes a program storage device readable by a machine, tangibly embodying a program of instructions executable by the machine to perform a method of providing user control of sharing of data between multiple Enterprise Resource Planning (ERP) systems. The method includes identifying types of shared data between the multiple ERPs, conveying the identified shared data types to a user, allowing the user to selectively load shared data to a parent realm based on the identified types of shared data, allowing the user to selectively indicate which data is not to be shared between ERPs to identified child realms, and providing sharing of shared data between child realms.

### BRIEF DESCRIPTION OF THE DRAWINGS

The invention may best be understood by referring to the following description and accompanying drawings that are used to illustrate embodiments of the invention. In the drawings:

FIG. 1 illustrates the connectivity of two ERPs with two enterprise applications.

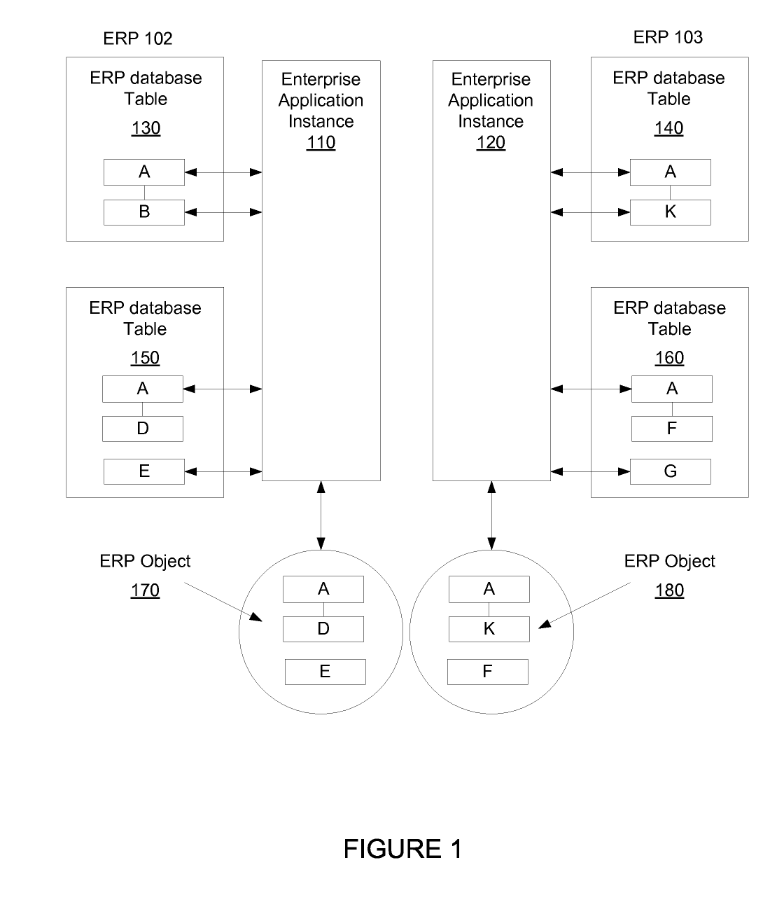

FIG. 2 illustrates a multi-organization configuration.

FIG. 3 illustrates a multi-organization configuration that can implement the described embodiments.

FIG. 4 is a flow chart that includes the steps of an example of a method of an enterprise application providing user control of sharing of data between multiple Enterprise Resource Planning (ERP) systems.

FIG. 5 shows an example of an enterprise application system that provides user control of sharing of data between multiple Enterprise Resource Planning (ERP) systems.

FIG. 6 shows another example of an enterprise application system that provides user control of sharing of data between multiple Enterprise Resource Planning (ERP) systems.

### DETAILED DESCRIPTION

A method and system of providing connectivity to multi-organization resource management systems simultaneously from varying external applications is described. The described embodiments allow multiple customers to utilize a single program as a SaaS (Software as a Service), which reduces cost and burden of upkeep on the customers.

Embodiments include variants and partitions used in a multi-organization configuration to model data in external applications. In this way, data from two or more external applications may be accessed and viewed simultaneously without the need of mapping at runtime. In one embodiment, the multi-organization configuration provides simultaneous access to a single business that has several different internal organizations, each with different data or requirements.

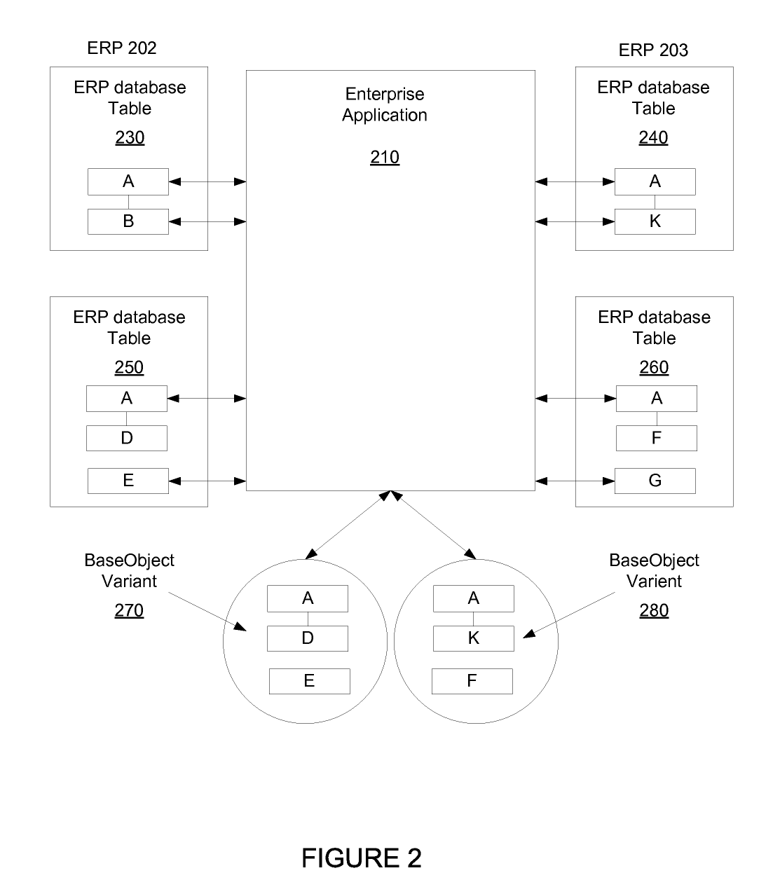

FIG. 2 illustrates a multi-organization configuration. Here, enterprise application 210 interfaces with two external applications, ERP 202 and ERP 203. The ERP 202 includes ERP database 230 and ERP database 250 and the ERP 203 includes ERP database 240 and ERP database 260. The enterprise application 210 models the ERPs within BaseObject variant 270 and BaseObject variant 280. In one embodiment, both BaseObject variant 270 and BaseObject variant 280 contain the attributes and behavior that relate to every object type (e.g. users, requisitions, units of measure, etc.) for both systems as base data. However, in alternative embodiments multiple BaseObjects would exist for each object type.

BaseObject variant 270 and BaseObject variant 280 are extendable to allow for the addition of extrinsic attributes and behavior, as will be further described below. Extrinsics are attributes added to a variant. Here, variants represent the extrinsic attributes that is in one but not the other of both the external and enterprise applications. This is because, at times, various organizations within a business may independently add extrinsic attributes to their external application, depending on their unique business requirements.

For example, FIG. 2 may represent a configuration with two external applications used by two separate organizations within a single business. For example, one external application can be in the United States (represented by ERP 202) and one external application can be in France (represented by ERP 203), which were developed by different groups, with different sets of requirements. Those two systems may have evolved over time to have slightly different notions of the resource data associated with a supplier, so that the two share some fields in common but diverge in others.

Variants define the data types (shape) and behavior of each individual external application. That is, variants are used to define differently shaped data of the same general type for the varying external applications. In one embodiment, methods that define the behavior (e.g. business rules and ordering modules) are also encapsulated in a variant on a per-variant basis for the different external applications. Variants may also be used to define required or validated fields. Although, in one embodiment, variants define the shape of the data, variants do not supply the data.

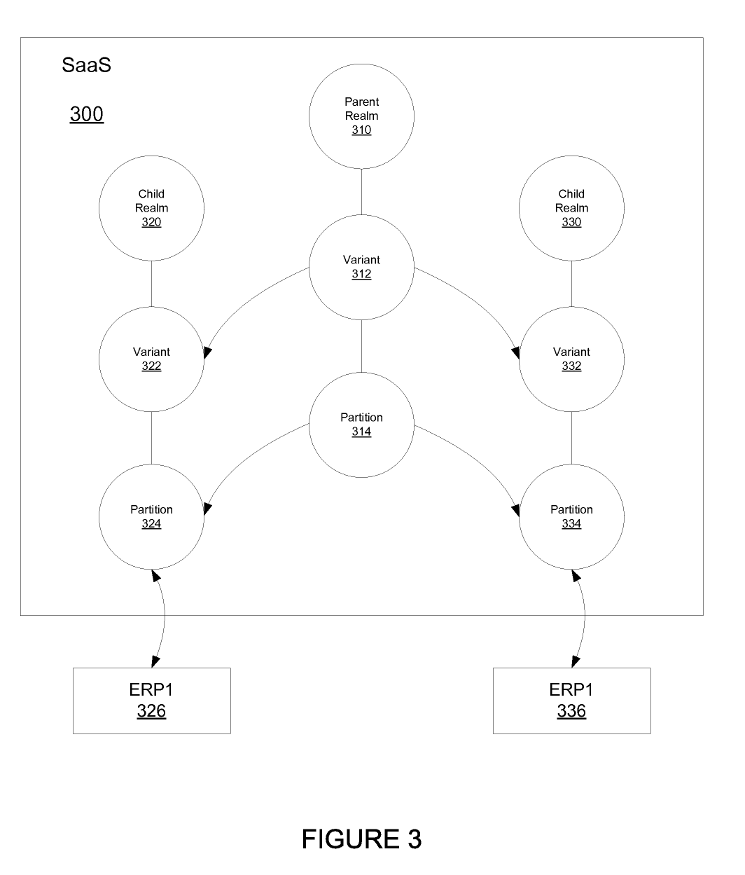

FIG. 3 illustrates a multi-organization configuration that can implement the described embodiments. This configuration includes by example, a parent realm 310 and two child realms 320, 330. The parent realm 310 includes a variant 312 and a partition 314. The child realm 320 includes a variant 322 and a partition 324. The child realm 330 includes a variant 332 and a partition 334. Clearly, additional child realms can be included. A couple of exemplary ERPs (ERP1, ERP2) 326, 336 are associated with each of the partitions 324, 334.

Each customer is able to access multiple realms/ERPs as a single system. The system (SaaS) 300 is one system from the customer's view, even though it represents multiple ERPs.

A base domain variant is selected for the parent realm and each of the child realms. For an embodiment, the base domain variant for the parent realm is selected for providing a highest level of data sharing between the child realms. For example, an ERP specific base domain variant may be selected for the parent realm because a majority of the child realms include the same ERP specific variant. Generally, a base domain variant is used as a template for each of the realm variants. For example, ERPs types can have an associated base domain variant. If, for example, child realms are associated with a specific ERP type, the base domain variant associated with the particular ERP type can be used as a template for the child realm's variant.

Various types of data can be shared between the partitions 314, 324, 334. Such data can include, for example, master data, customization data and catalog data. The parent realm partition 314 is where shared data can be stored, which can then be copied (replicated) to each of the child realm partitions 324, 334.

Each child realm 320, 330 can only access master data and customization data within its own partition 324, 334. The partition 314 of the parent realm sources master data and customization data to the child partitions 324, 334. Additionally, the ERPs 326, 336 source data to the child partitions 324, 334. The shape of the variants 322, 332 of the child realms map one-for-one with the shape of the data in the ERPs 326, 336.

For an embodiment, the master data is physically replicated from the parent realm to the child realms. If at least a portion of the master data already exists within a child realm, then the master data is inserted or updated accordingly. For an embodiment, master data that has been replicated to a child realm is tagged, thereby preventing another source from updating the master data in the child realm. Further, the master data can be integrated with previously existing master data of the child realms.

For the customization data, extensions can be replicated to the child realms, which allows for changes in shapes on the fly. Allocations are dynamic, and new shapes can be created that previously did not exist. The extensions can include fields and/or shapes. Embodiments include allowing the child realms to over-ride the customizations. Further, process rules can be replicated to child realms.

Catalog data, however, is loaded to the parent realm partition 314, but not replicated to the child partitions 324, 334 like the master data and customization data. The child realms are able to access catalog data within the partitions of any other realm (parent or child) within a related family. A family can be defined as a set of related children realms and a parent realm that are considered a single system.

The described embodiments provide methods of providing user control of sharing of data between multiple ERPs. Generally, this includes identifying types of shared data between the multiple ERP. The identified shared data types are conveyed to a user. The user is allowed to selectively load shared data to a parent realm based on the identified types of shared data. The user is allowed to selectively indicate data not to be shared between identified child realms. Sharing of shared data is provided between parent and child realms. Data is not shared between child realms.

Embodiments include user interfaces for allowing the user to selectively load shared data to the parent realm, and for allowing the user to selectively load data to the child realms.

Embodiments include tagging the shared data as replicated, thereby allowing an integrated layer to treat the share data accordingly. This allows tracking of what has been shared, and allows tracking of what has been over-ridden. A user interface can be included for allowing a user to over-ride the shared data and this override is also tagged. The user over-rides can be tracked and protected during future replication of the shared data to the child realms.

Embodiments allow for merging of data for allowing user fine-tuning of relationship data. The fine-tuning includes, for example, defining relationships in parent realms and/or child realms, and providing merging of these relationships.

An embodiment includes a single user sign-on. The single user sign-on allows a customer to sign-on once, and view the enterprise application as a single system, and allows the user to access the parent realm and the child realms as a single system. Additionally, selectivity of choosing which child realms the end-user can access is provided. That is, the end-user can be provided access to some child realms, and denied access to other child realms.

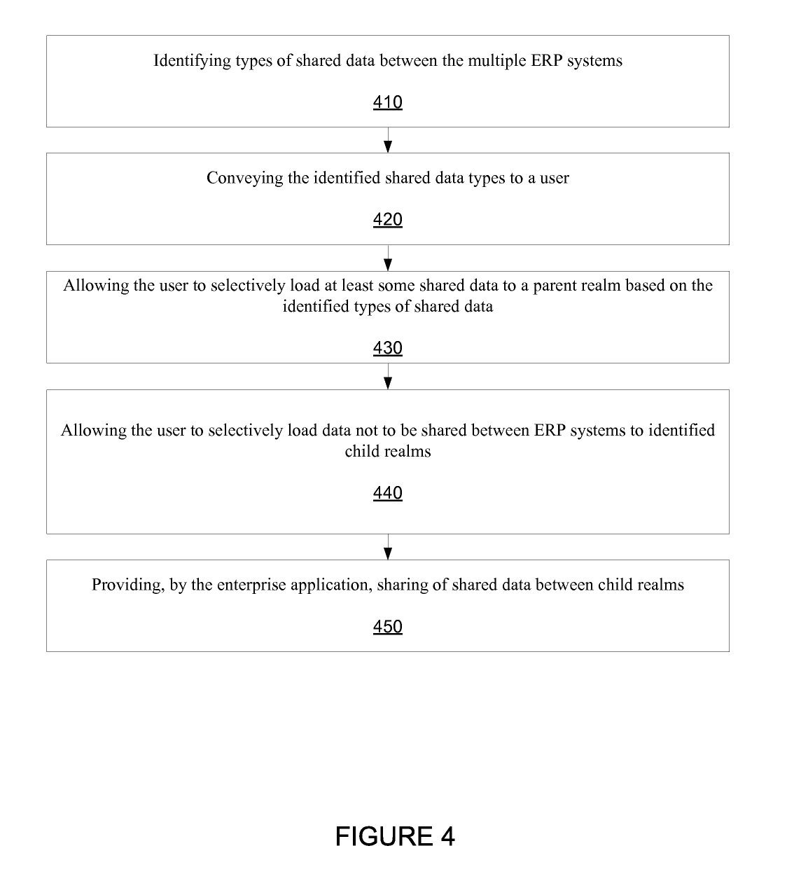

FIG. 4 is a flow chart that includes the steps of an example of a method of an enterprise application providing user control of sharing of data between multiple Enterprise Resource Planning (ERP) systems. A first step 410 includes identifying types of shared data between the multiple ERP systems. A second step 420 includes conveying the identified shared data types to a user. A third step 430 includes allowing the user to selectively load at least some shared data to a parent realm based on the identified types of shared data. A fourth step 440 includes allowing the user to selectively load data not to be shared between ERP systems to identified child realms. A fifth step 450 includes providing, by the enterprise application, sharing of shared data between child realms.

It is to be understood that the enterprise application is generally operable on one or more servers that are connectable through a network to one or more users, and connectable through a network to one or more servers (or computers) that the multiple Enterprise Resource Planning (ERP) systems are operating on.

For embodiments, the shared data is data that is useful to load once and share between realms representing multiple ERP sites. Examples of shared data include, but are not limited to, catalogs, customizations, and master data. Examples of customization data include meta-data that defines additional fields in classes stored in database, approval rules, and eForm templates. There are a large number of kinds of master data common to all ERPs. Examples of master data include users, passwords, group (of Users), addresses, bank account types, commodity codes, suppliers, expense policy types, payment locations, and unit of measures.

The term “realm” can alternatively be termed a “site”. The described embodiments include a parent-child model. One parent site (realm) groups together a set of child sites (realms). The parent site (realm) holds the data common (shared) to all child sites (realms). Each child site (realm) is typically associated with an external (to the enterprise application) ERP system. Within the child site (realm) is held the data that is specific to that ERP system. A parent site (realm) holds the three types of data (catalog, customizations, master data). A child site (realm) can hold those three types of data plus it holds the transactional data. Transaction data, for example, Purchase Orders, Requisitions and Expense Reports, are ERP specific.

For embodiments, data types are picked that could be meaningful to multiple ERP sites. For embodiments, customers (users) cannot change the types of share data, but they can decide what instances of data is shared.

Embodiments include various methods of loading data to a parent realm. For example, several techniques selectable by a customer (user) include exchange of files (csv or xml) with an external system, web services, and direct editing or creating via the User Interface. A user interface can be provided for allowing the user to selectively load shared data to the parent realm. Data can be loaded into child realms using similar techniques as loading data into parent realms. A user interface can also be provided for allowing the user to selectively load shared data to the child realms. Embodiments further include preventing sharing of data not to be shared between child realms.

Embodiments include selecting a base domain variant type for the parent realm and each of the child realms.

Embodiments can include multiple variants in the enterprise application to support different ERP systems. For example, variants of the data can support, for example, external SAP ® ERP systems, external Oracle® ERP systems, and/or other types of external ERP systems. For these embodiments, all realms must be one of these three base domain variant types. Parent and child do not have to be of the same type. A variant allows meta-data for a class (Supplier, User, etc.) to be different in the list of fields within the class. The different fields are necessary to support and integrate with the ERP system.

A BaseObject is an instance of data of a class (Supplier, User, etc.). Because the class can be different by variant, the BaseObject also will be.

Embodiments include selecting the variant for the parent realm for providing a highest level of data sharing between the child realms. For example, an ERP specific base domain variant can be selected for the parent realm because a majority of the child realms include the same ERP specific variant. For embodiments, some master data is different for each base domain variant. This data can only be replicated from parent to child site if both sites are of the same base domain variant, which can be referred to as a single-variant configuration. As a result, there is more master data that can potentially be shared than when sites have different base domain variants. If parent and child are different base domain variants, only data that is the same in the two base domain variants can be replicated. This can be referred to as a multi-variant configuration.

As previously mentioned, for embodiments, the shared data types comprise master data, customization data and catalog data. For the master data, the embodiment includes physically replicating the master data from the parent realm to a child realm. If at least a portion of the master data already exists within a child realm, then the master data is inserted or updated accordingly. Further, master data that has been replicated to a child realm is tagged, thereby preventing another source from updating the master data in the child realm. For embodiments, this ‘tag’ is recorded in the data in the child realm to indicate that the data came from the parent realm.

When the tag is set, the methods of uploading data into the child site (Files, Web Services, UI) will not allow changes, except for overrides. Accordingly, embodiments include providing a user interface for allowing a user to over-ride the replication tagging of the shared data. Some data types are allowed to be changed in child site even though they are tagged as replicated from the parent site. In these cases, changes in the child cause the data to be tagged as ‘child override’ and future changes to same data in parent site are not replicated to child site. For embodiments, there are also several kinds of relationships (mappings between data) that can be edited in child and during replication, the child mappings are merged with the parent mappings. Examples of these mappings include groups to users, groups to child groups (groups that extend other groups), users to ship to addresses, users to billing addresses, common suppliers to (ERP specific) suppliers.

Embodiments include tracking and maintaining the user over-ride during future downloads of shared data to the child realms. For embodiments, when data is tagged as ‘child override’, any changes to parent are not replicated (downloaded) to child realm. For example, say User123 is created in a parent site (realm), and system replicates it down to child site (realm). Next, User123 is edited on child site (realm), causing User123 to be tagged as child override. If User123 is changed in the parent site (realm), it is not replicated to that child site (realm). Note that ‘child override’ is by child site (realm), so User123 may be child overridden in Site1 but not in Site2.

Embodiment further includes integrating the master data with previously existing master data of the child realms. For example, if a child site (realm) starts with the list of Users (user1, user2, user3, user4), and the parent site has this set of Users (user3, user10, user11), after users are replicated from parent to child, the child site (realm) now has this list of Users (user1, user2, user3, user4, user10, user11). User3 has been updated to match the parent site (realm) values.

For customization data, embodiments further include replicating extensions to child realms. This allows for changing shapes on the fly. Allocations are dynamic, and classes can be created that previously did not exist.

For an embodiment, the extensions include fields. For embodiments, fields include a piece of data in a class. Examples of fields include, for example, ‘name’, ‘birth date’, ‘salary’. For embodiments, extensions include classes.

For embodiments, the child realms are allowed to over-ride the customizations. Customizations can be created/edited in either the parent or child. For embodiments, only the customizations in parent are replicated to child sites. Any customization created/edited in child site is only used within that child site. For embodiments, process rules are replicated to child realms.

For catalog data, embodiments include storing the catalog data only in the parent realm. Embodiments further include allowing each child realm to select at least one catalog from the parent realm for access by the child realm. For an embodiment, within a child site user interface, there is a list of all catalogs loaded into the parent site. The user interface allows selection of which catalogs are visible (shared) with that child site. Each child site can chose (select) different catalogs.

An embodiment includes allowing search queries of the catalog data to be defined by access selections of the child realms. For embodiments, catalogs support various queries (searches) on the catalogs. These queries can search across the child sites catalogs and the selected set of parent site catalogs. Internally, the queries are adjusted to only use parent catalogs that have been selected.

Embodiments allow merging of data, wherein the user defines a relationship between parent realm and child realm, and the enterprise application merges the relationships within the child realm.

Embodiment includes a single user sign-on, wherein the single sign-on allows an end-user to sign-on once, and view as a single system, and allows the end-user to access the parent realm, the child realms and ERPs as a single system. Embodiments further include providing selectivity of choosing which child realms the end-user can access. For embodiments, the end-user can be provided access to some child realms, and denied access to other child realms. This selectivity can be provided, for example, by breaking the user data into two pieces, shared user data that applies to all ERPs and hence to all sites, and the ERP specific portion (also referred to as “partitioned user”) that only applies to one ERP site. For a user to log into a site, both pieces of data must be present. If for User123, its shared user data is loaded into parent site, child1 site and child2 site, but the ERP specific portion is only loaded into parent site and child1 site, then User123 can only access the parent site and the child1 site. User123 cannot see child2 site.

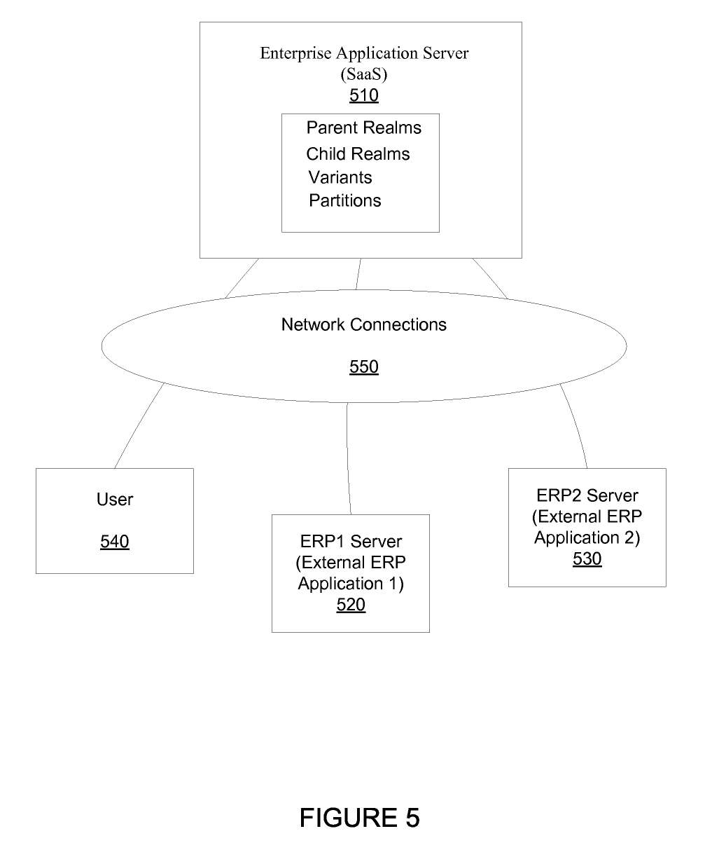

FIG. 5 shows an example of an enterprise application system that provides user control of sharing of data between multiple Enterprise Resource Planning (ERP) systems. The exemplary system of FIG. 5 includes an enterprise application server 510 that is interfaced through network connections 550 to a user 540, a first ERP application server 520 and a second ERP application server 530. While only a single user 540 (which is typically a user server or computer) is shown in FIG. 5, typically, many users (customers) have access to the enterprise application server 510. Additionally, although only two ERP servers 520, 520 are shown connected to the enterprise application server 510, there is no limit on the number of ERP servers that can be connected to the enterprise application server 510. The enterprise application system of FIG. 5 allows the multiple customers (users) to utilize a single program as a SaaS (Software as a Service), which reduces cost and burden of upkeep on the customers. The enterprise application server 510, and the ERP servers 520, 520 can each include one or more networked servers.

As described, embodiments of the enterprise application server include variants and partitions used in a multi-organization configuration to model data in external applications. In this way, data from two or more external applications may be accessed and viewed simultaneously without the need of mapping at runtime. In one embodiment, the multi-organization configuration provides simultaneous access to a single business (user) that has several different internal organizations, each with different data or requirements.

As shown, the enterprise application server 510 is interfaced with at least one server of each of the multiple ERP systems (applications) 520, 530 through a network 550, and further interfaced to at least one computer of the user 540 through the network 550. For an embodiment, the enterprise application server 510 is operable to prevent sharing of data not to be shared between child realms. For an embodiment, the enterprise application server 510 is operable to provide a user interface that allows the user 540 to selectively load shared data to the parent realm. For an embodiment, the enterprise application server 510 is operable to provide a user interface for allowing the user 540 to selectively load data to the child realms.

A typical sequence of events could include the user 540 logging in through the network 550 to the enterprise application server 510. After logging in, the user is then taken to the parent and child realms. The user 540 is then connected to the ERP1 server 520 or the ERP2 server 530.

As previously described, for embodiments, the share data types include master data, customization data and catalog data. For embodiments, for master data, the enterprise application server 510 physically replicates the master data from the parent realm to a child realm. If at least a portion of the master data already exists within a child realm, then the enterprise application server inserts and updates the master data accordingly.

For an embodiment, the enterprise application server 510 tags master data that has been replicated to a child realm. This prevents another source from updating the master data in the child realm. For an embodiment, the enterprise application server 510 is operable to provide a user interface for allowing a user 540 to over-ride the replication tagging of the shared data. Further, the enterprise application server tracks and maintains the user over-ride during future downloads of shared data to the child realms. For customization data, embodiments provide replication of extensions to child realms.

An embodiment includes a program storage device readable by a machine (for example, enterprise application server) tangibly embodying a program of instructions executable by the machine to perform a method of providing user control of sharing of data between multiple Enterprise Resource Planning (ERP) systems. When the program is executed, the machine identifies types of shared data between the multiple ERP systems, conveys the identified shared data types to a user, allows the user to selectively load at least some shared data to a parent realm based on the identified types of shared data, allows the user to selectively load data not to be shared between ERP systems to identified child realms, and provides sharing of shared data between child realms.

For the described embodiments, variants define data types (shape) and behavior of each individual application. That is, variants are used to define differently shaped data of the same general type for varying external applications. Variants define the shape of the data, variants do not supply the data. The following table provides several variants (Oracle, SAP, Plain) that each include a set of attributes. Each collection of attributes defines the shape of the data.

| Oracle (for example, ERP1) | SAP(for example, ERP2) | Plain |
|---|---|---|
| User Object | User Object | User Object |
| Name | Name | Name |
| Email | Email | Email |
| Phone | Phone | Phone |
| Ship to address | Fax | |
| | Account id | |

As shown, the variant labeled “Plain” includes the shared data. That is, the plain data is common to all the variants. The other variants extend the plain shape by adding attributes. For the example shown, the Oracle variant adds the “ship to address” attribute, and the SAP variant adds the “fax” and “account id” attributes. As stated, the collection of attributes defines the shape of the variant.

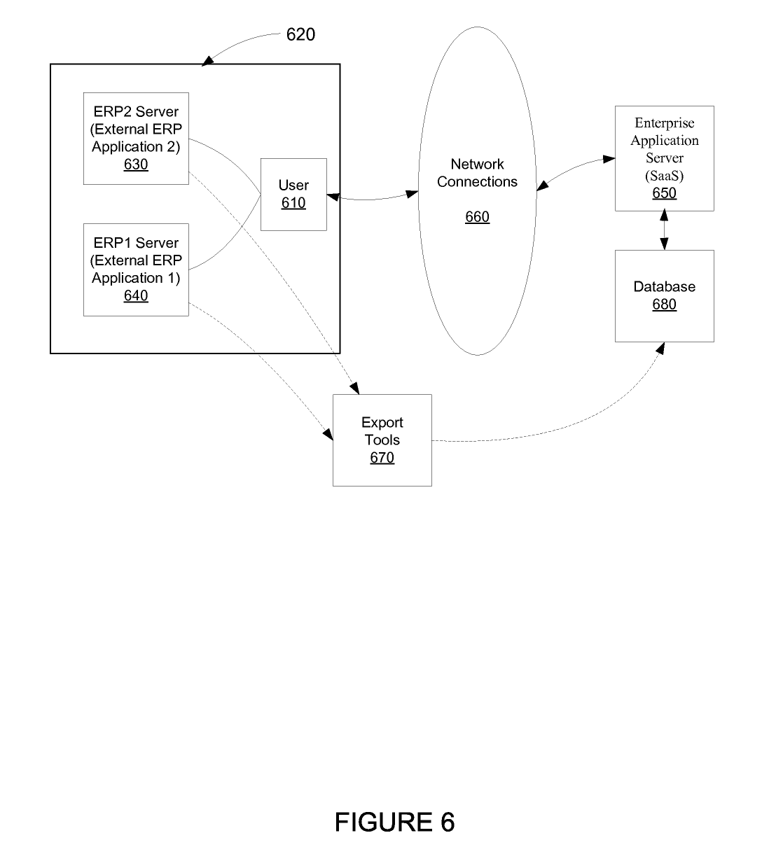

FIG. 6 shows another example of an enterprise application system that provides user control of sharing of data between multiple Enterprise Resource Planning (ERP) systems. This embodiment includes a user 610. The user 610 has within a fire-wall 620 of the user 610, multiple ERP systems (ERP1 630 and ERP2 640).

The user 610 can access the enterprise application 650 through a network 660. The enterprise application 650 maintains access to a database 680 that includes the information and data of the ERP systems (ERP1 630 and ERP2 640). Export tools 670 can be utilized to periodically update the database 680 with the information and data of the ERP systems (ERP1 630 and ERP2 640). For embodiments, the export tools 670 do not have direct access to the database 680. The data is sent via network 660 though SasS 650 to Database 680.

As described, embodiments of the enterprise application server 650 include variants and partitions used in a multi-organization configuration to model data in external applications. In this way, data from two or more external applications (ERP1 630 and ERP2 640) may be accessed and viewed simultaneously without the need of mapping at runtime. In one embodiment, the multi-organization configuration provides simultaneous access to a single business (user 610) that has several different internal organizations, each with different data or requirements.

For an embodiment, the enterprise application server 650 is operable to prevent sharing of data not to be shared between child realms. For an embodiment, the enterprise application server 650 is operable to provide a user interface that allows the user 610 to selectively load shared data to the parent realm. For an embodiment, the enterprise application server 650 is operable to provide a user interface for allowing the user 610 to selectively load data to the child realms.

Although specific embodiments have been described and illustrated, the described embodiments are not to be limited to the specific forms or arrangements of parts so described and illustrated. The embodiments are limited only by the appended claims.

What is claimed:

1. A computer-method of an enterprise application providing user control of sharing of data between multiple Enterprise Resource Planning (ERP) systems, comprising:
identifying types of shared data between the multiple ERP systems;
conveying the identified shared data types to a user;
allowing the user to selectively load at least some shared data to a parent realm based on the identified types of shared data;
allowing the user to selectively load data not to be shared between ERP systems to identified child realms; and
providing, by the enterprise application, sharing of shared data between child realms.

2. The method of claim 1, further comprising preventing sharing of data not to be shared between child realms.

3. The method of claim 1, further comprising providing a user interface for allowing the user to selectively load shared data to the parent realm.

4. The method of claim 1, further comprising providing a user interface for allowing the user to selectively load data to the child realms.

5. The method of claim 1, further comprising selecting a variant type for the parent realm and each of the child realms.

6. The method of claim 5, further comprising selecting the variant for the parent realm for providing a highest level of data sharing between the child realms.

7. The method of claim 1, wherein the shared data types comprise master data, customization data and catalog data.

8. The method of claim 7, wherein for master data, further comprising:
physically replicating the master data from the parent realm to a child realm;
if at least a portion of the master data already exists within a child realm, then inserting and updating the master data accordingly.

9. The method of claim 8, further comprising:
tagging master data that has been replicated to a child realm, thereby preventing another source from updating the master data in the child realm.

10. The method of claim 9, further comprising providing a user interface for allowing a user to over-ride the replication tagging of the shared data.

11. The method of claim 10, further comprising tracking and maintaining the user over-ride during future replications of shared data to the child realms.

12. The method of claim 8, further comprising integrating the master data with previously existing master data of the child realms.

13. The method of claim 7, wherein for customization data, further comprising replicating extensions to child realms.

14. The method of claim 13, wherein the extensions comprise fields.

15. The method of claim 13, wherein the extensions comprise classes.

16. The method of claim 13, further comprising allowing the child realms to over-ride and add to the customizations.

17. The method of claim 13, further comprising replicating process rules to child realms.

18. The method of claim 7, wherein for catalog data, storing the catalog data only in the parent realm.

19. The method of claim 18, further comprising allowing each child realm to select at least one catalog from the parent realm for access by the child realm.

20. The method of claim 18, further comprising allowing search queries of the catalog data to be defined by access selections of the child realms.

21. The method of claim 8, allowing merging of data, wherein the user defines a relationship between parent realm and child realm, and the enterprise application merges the relationships within the child realm.

22. The method of claim 1, further comprising a single user sign-on, wherein the single sign-on allows an end-user to sign-on once, and view as a single system, and allows the end-user to access the parent realm, the child realms and ERPs as a single system.

23. The method of claim 22, further comprising providing selectivity of choosing which child realms the end-user can access.

24. An enterprise application system that provides user control of sharing of data between multiple Enterprise Resource Planning (ERP) systems, comprising:
an enterprise application server operable to identify types of shared data between the multiple ERP systems;
the enterprise application server operable to convey the identified shared data types to a user connected to the enterprise application network;
the enterprise application server operable to allow the user to selectively load at least some shared data to a parent realm based on the identified types of shared data;
the enterprise application server operable to allow the user to selectively load data not to be shared between ERP systems to identified child realms; and
the enterprise application server providing sharing of shared data between child realms.

25. The system of claim 24, further comprising the enterprise application server interfaced with at least one server of each of the multiple ERP systems through a network, and further interfaced to at least one computer of the user through the network.

26. The system of claim 25, further comprising the enterprise application server operable to prevent sharing of data not to be shared between child realms.

27. The system of claim 25, further comprising the enterprise application server operable to provide a user interface that allows the user to selectively load shared data to the parent realm.

28. The system of claim 24, further comprising the enterprise application server operable to provide a user interface for allowing the user to selectively load data to the child realms.

29. The system of claim 24, wherein the share data types comprise master data, customization data and catalog data.

30. The system of claim 29, wherein for master data, further comprising:
the enterprise application server physically replicating the master data from the parent realm to a child realm; and
if at least a portion of the master data already exists within a child realm, then enterprise application server inserting and updating the master data accordingly.

31. The system of claim 30, further comprising:
the enterprise application server tagging master data that has been replicated to a child realm, thereby preventing another source from updating the master data in the child realm.

32. The system of claim 31, further comprising the enterprise application server operable to provide a user interface for allowing a user to over-ride the replication tagging of the shared data.

33. The system of claim 32, further comprising the enterprise application server tracking and maintaining the user over-ride during future downloads of shared data to the child realms.

34. The method of claim 29, wherein for customization data, further comprising replicating extensions to child realms.

35. The method of claim 29, wherein for catalog data, further comprising replicating extensions to child realms.

36. A program storage device readable by a machine, tangibly embodying a program of instructions executable by the machine to perform a method of providing user control of sharing of data between multiple Enterprise Resource Planning (ERP) systems, comprising:
identifying types of shared data between the multiple ERP systems;
conveying the identified shared data types to a user;
allowing the user to selectively load at least some shared data to a parent realm based on the identified types of shared data;
allowing the user to selectively load data not to be shared between ERP systems to identified child realms; and
providing sharing of shared data between child realms.
